(19) United States
(12) Patent Application Publication
(10) Pub. No.: US 2004/0193373 A1
(43) Pub. Date: Sep. 30, 2004

(54) Autonomous navigation error correction

(75) Inventors: John G. Beauregard, Palos Verdes, CA (US); David B. Levin, Rancho Santa Margarita, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: THE BOEING COMPANY

(21) Appl. No.: 10/397,012

(22) Filed: Mar. 25, 2003

(51) Int. Cl. G01C 21/26

(52) U.S. Cl. 701/213; 701/215

(57) ABSTRACT

A method and system for continuously monitoring a constellation of Global Positioning System (GPS) satellites from space is disclosed. The system utilizes a plurality of GPS receivers respectivelyinstalled on-board the GPS satellites. The on-board GPS receivers receive the navigation signals transmitted by its host GPS satellite in addition to the navigation signals from all of the GPS satellites in view. The system further utilizes a Kalman filter which can also be installed on-board one or more of the GPS satellites in space to achieve further isolation from the master control station. The method comprises the steps of providing a plurality of GPS receivers on-board the GPS satellites and substantially continuously receiving at the GPS receivers navigation signals from the GPS satellites in view of the GPS receivers, and continuously determining a range from the navigation signal of each GPS satellite in view of the GPS receivers.

### BACKGROUND OF THE INVENTION

1. Field of the Invention

The present invention relates generally to a Global Positioning System (GPS), and in particular to a method and system for continuously monitoring a constellation of GPS satellites from space rather than ground monitor stations.

2. Description of the Related Art

The Global Positioning System (GPS) is a satellite-based radio navigation system developed and operated by the United States of America Department of Defense. GPS has revolutionized the manner in which the world navigates. GPS allows land, airborne and sea users to constantly determine their three-dimensional position, velocity, and time anywhere in the world with a precision and accuracy far better than other radio navigation systems currently available. The GPS consists of three segments: user, space and control.

The user segment consists of individual receivers, processors, and antennas that allow land, airborne or sea operators to receive GPS satellite broadcasts and compute their precise position, velocity and time from the information received from the satellites.

The space segment consists of twenty-four GPS satellites in six orbital planes, each orbit having four satellites per plane, provides accurate and reliable signals from Earth orbiting satellites. These GPS satellites are at an altitude of approximately 20,183 kilometers (10,898 nautical miles) so that they circle the earth once every 12 sidereal hours. Each orbital plane is inclined 55 degrees with respect to the equator to provide reasonable elevation angles to the user at high latitudes. The GPS satellites are positioned so that at any time between five and eight satellites are “in view” of a GPS receiver. GPS receivers can determine their position to within 100 meters horizontal and 150 meters vertical accuracy anywhere on the surface of the Earth. These GPS satellites continuously broadcast navigation signals to users throughout the world.

The control segment consists of five land-based control and monitoring stations located in Colorado Springs (master control station), Hawaii, Ascension Island, Diego Garcia, and Kwajalein Island. Corrections are made to data in the GPS satellites at periodic intervals by sending commands up to the satellites from ground antenna. These ground stations monitor transmissions from the GPS satellites as well as the operational status of each satellite and its exact position in space. The master ground station transmits corrections for the satellite's position and orbital data back to the satellites. The satellites synchronize their internally stored position and time with the data broadcast by the master control station, and the updated data are reflected in subsequent transmissions to the user's GPS receiver, resulting in improved prediction accuracy. The GPS ground stations and satellites are the responsibility of the U.S. Department of Defense.

A worldwide network of ground monitor stations currently monitors the ephemeris and clock error of each of the satellites in the GPS constellation and corrections are radioed to the GPS satellites at least every 24 hours. These corrections are transmitted on the navigation signal by each satellite to potential users to calculate position and time. Between satellite corrections intervals the errors accumulate. The accuracy of user position and time is dependent on the accuracy of the ephemeris and clock error corrections. The worldwide network of ground stations is expensive to operate and maintain. They are subject to their own error sources and they are vulnerable to attack and are a security risk to the GPS system. There is therefore a need for improved accuracy, reliability, integrity and security of the GPS system. The present invention can greatly reduce the complexity and cost of operating and maintaining the GPS control segment while improving the security and accuracy of the GPS system. The present invention can further provide the GPS system with the needed system integrity monitoring and reporting and eliminating the need for GPS augmentation systems. The present invention satisfies that need.

### SUMMARY OF THE INVENTION

The present invention is a method and system for continuously monitoring a constellation of Global Positioning System (GPS) satellites from space rather than ground monitor stations, as is the current practice. The present invention greatly reduces the complexity and cost of the GPS control segment while improving accuracy, reliability and security. The present invention eliminates the need for all ground monitor stations and ground antennas outside the continental United States. However, United States based monitor stations are still necessary to anchor the GPS constellation to the Earth and the GPS atomic clock standard.

The present invention system utilizes a plurality of GPS receivers installed on-board each GPS satellite. The on-board GPS receivers receive navigation signals transmitted by its host GPS satellite in addition to the navigation signals from all of the other GPS satellites in view. This navigation signal from the host GPS satellite is undesirable and is of a high intensity signal than the desired navigation signals from the other GPS satellites in view. Since the host navigation signal is known precisely, it can be cancelled from the GPS receiver's radio frequency (RF) or from the derived navigation code. This technique is common in modem communication systems with demonstrated isolation in excess of 30 db. The system further utilizes a Kalman filter that can also be housed on one or more of the GPS satellites in space to achieve further isolation from the master control station in the event the master control station is inoperable due to a terrorist, nuclear or other forms of attack

It is an object of the present invention to provide a method and system for continuously monitoring each GPS satellite in the GPS constellation from space rather than from ground monitor stations, so that it greatly reduce the complexity and cost of the GPS control segment while improving accuracy, reliability and security.

It is also an object of the present invention to provide a GPS receiver on-board each GPS satellite of the GPS constellation and monitor the navigation signals from all satellites in view to determine the range to each satellite.

It is an additional object of the present invention to provide a method and system so that if five or more satellite navigation signals are simultaneously received from a single GPS receiver, then a faulty satellite navigation signal can be isolated using algorithms, such that the fault information can be transmitted to the affected GPS satellite to form an integrity message that can be added to the navigation signals of the affected satellite.

It is still a further object of the present invention to provide a GPS system wherein integrity can be monitored and reported on the navigation signal, so that the GPS system can eliminate the need for GPS augmentation systems and associated receivers.

It is still a further object of the present invention to provide a method and system for continuously receiving and updating ephemeris data and clock data rather than every 24 hours, as is the current practice.

It is still a further object of the present invention to provide a method and system which eliminates the dependence of foreign-based ground monitor systems.

It is still a further object of the present invention to provide a Kalman filter on-board one or more of the GPS satellites of the GPS constellation in space, so that the ephemeris and clock error of each satellite can be calculated and the correction errors can be transmitted back to each satellite via a communication link and further isolate the GPS satellites from the master control station in the event the master control station is inoperable.

Further novel features and other objects of the present invention will become apparent from the following detailed description, discussion and the appended claims, taken in conjunction with the drawings.

### BRIEF DESCRIPTION OF THE DRAWINGS

Referring now to the drawings in which like reference numbers represent corresponding parts throughout:

FIG. 1 is an illustration from space of the orbit and satellite positions of a constellation of Global Positioning System (GPS) satellites;

FIG. 2 is a block diagram depicting a system for continuously monitoring each GPS satellite of the GPS constellation from space;

FIG. 3 is a flow chart depicting a GPS receiver used to practice the present invention;

FIG. 4 is a flow chart depicting exemplary method steps used to practice one embodiment of the present invention; and

FIG. 5 is a flow chart depicting exemplary method steps used to calculate the ephemeris data and clock error data of a GPS satellite.

### DETAILED DESCRIPTION OF PREFERRED EMBODIMENTS

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

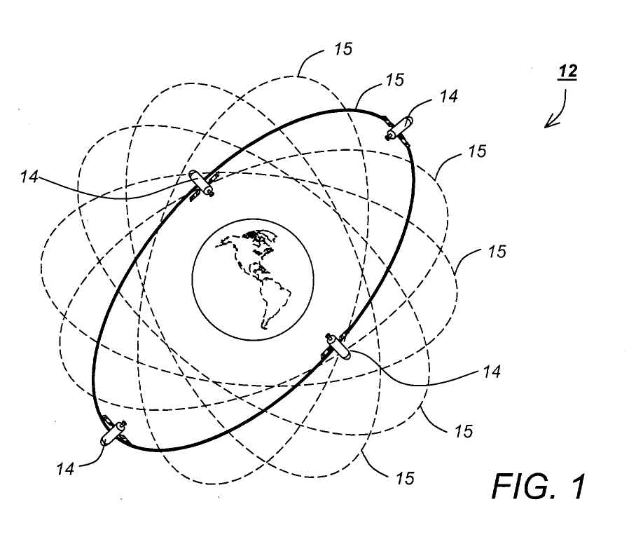

FIG. 1 illustrates a space view 10 of a Global Positioning System (GPS) constellation 12 of GPS satellites 14. The GPS constellation 12 includes 24 GPS satellites 14 in six orbital planes 15, each orbit having four satellites 14 per plane (for illustrative purposes, the satellites 14 for only a single orbital plane 15 are illustrated in FIG. 1). The GPS constellation 12 provides accurate and reliable signals from Earth orbiting satellites. These GPS satellites 14 are at an altitude of approximately 20,183 kilometers (10,898 nautical miles) so that they circle the Earth once every 12 sidereal hours. Each orbital plane 15 is inclined 55 degrees with respect to the equator to provide reasonable elevation angles to the user at high latitudes. The GPS satellites 14 are positioned so that at any time between five and eight satellites are “in view” to a GPS receiver, it can determine their position to within 100 meters horizontal and 150 meters vertical accuracy anywhere on the surface of the Earth. These GPS satellites 14 continuously broadcast both position and time data to users throughout the world. It is noted that the term “in view” herein refers to a GPS satellite whose navigation signal beam impinges on the GPS receivers.

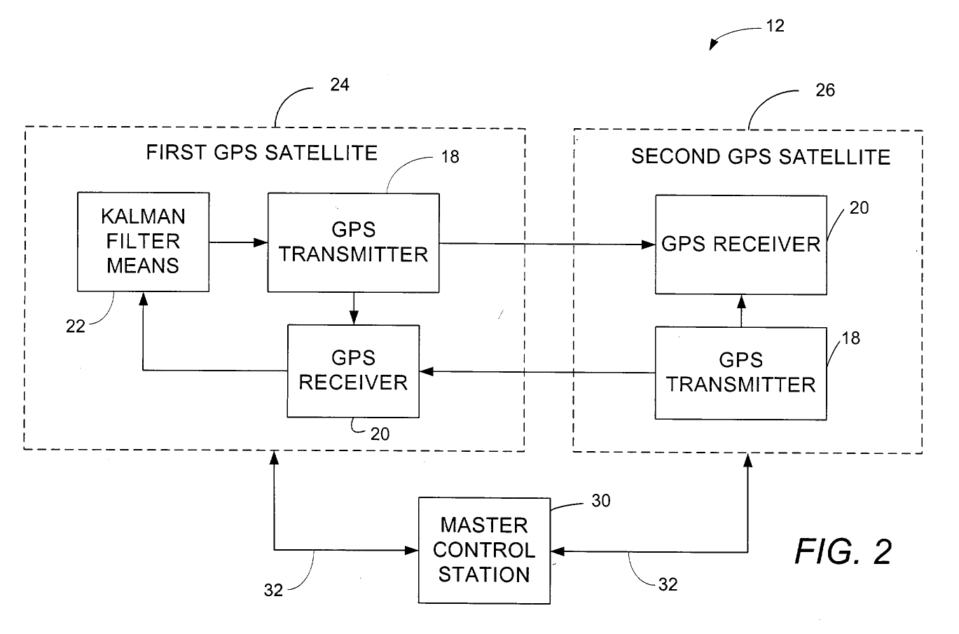

FIG. 2 is a block diagram of one embodiment of a system for continuously monitoring the GPS constellation 12 of twenty-four GPS satellites in six orbital planes at 55 degrees inclination and 12 sidereal hour periods from space. The present invention system uses the existing GPS satellite geometry with its 12 sidereal hour orbits. No modifications are required to the GPS orbits.

For clarity purposes in FIG. 2, only two GPS satellites with its associated support systems out of the twenty-four GPS satellites are illustrated. Those skilled in the art will recognize many modifications may be made to this configuration without departing from the scope of the present invention. For example, those skilled in the art will recognize that any combination of the above components, or any number of different components and other devices, may be used with the present invention.

A first GPS satellite includes a GPS transmitter 18, a GPS receiver 20 and a Kalman filter 22, as shown in block 24. A second GPS satellite includes a GPS transmitter 18, a GPS receiver 20 and without the Kalman filter means 22, as shown in block 26. It will be appreciated that the third, fourth, fifth and so on of the GPS satellites are configured similar to the first and second GPS satellites shown in blocks 24 and 26. It will be further appreciated that a Kalman filter means 22 can be installed on-board one or more of the GPS satellites to implement the present invention system.

Each GPS satellite 14 may further include conventional support systems such as power, attitude control, propulsion, thermal control, communication, and payload (not shown). The primary payload on a GPS satellite is the navigation payload with its associated atomic clock. The navigation payload broadcasts navigation signals on two separate L band frequencies, L1 at 1575.42 MHz and L2 at 1227.6 MHz. The civilian users navigate from the signals broadcast on the L1 frequency. The signals broadcast on the L2 frequency provide greater accuracy but are encrypted for military use only. These navigation signals are broadcast continuously, with very infrequent interruption for maintenance on one satellite at a time.

These GPS satellites 14 continually transmit microwave L-band radio signals. These signals include timing patterns relative to the satellite's on-board precision clock (which is kept synchronized by a master control station 30 located within the continental United States) as well as a navigation message giving the precise orbital positions of the satellites. GPS receivers 20 include processors for processing the radio navigation signals, computing ranges to the GPS satellites 14, and by triangulating these ranges, the GPS receiver 20 determines its position and its internal clock error. Similar processing can be performed by other processors disposed on the satellite 14.

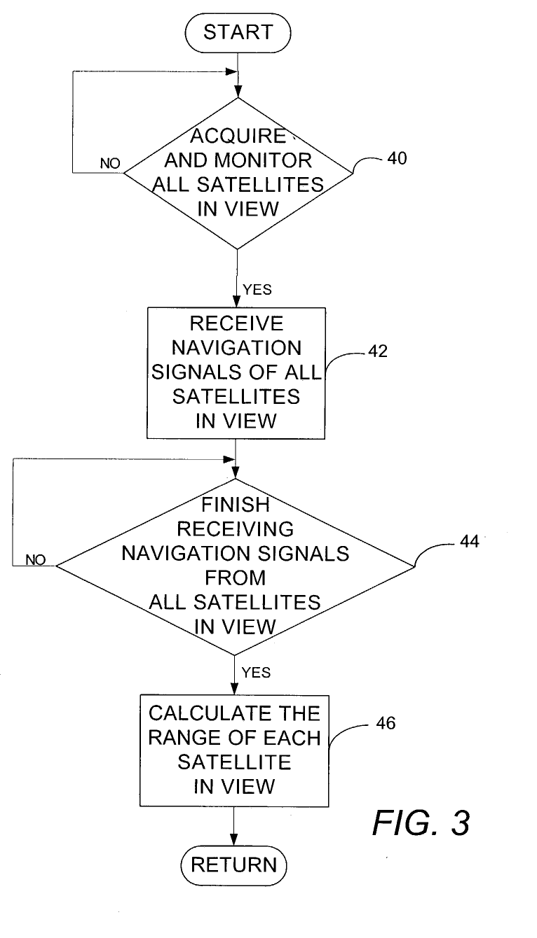

FIG. 3 is a flow chart depicting exemplary process steps of a GPS receiver 20 which can be used to implement the present invention. The operation of the GPS receiver 20 will be described with reference to the flow chart shown in FIG. 3, wherein 40-46 designate operational steps to be performed by the GPS receiver 20. Upon initiation of the GPS receiver 20, it is checked whether or not all GPS satellites 14 in view are acquired by the GPS receiver 20, as shown in step 40. If it is, navigation signals are received that include respective ephemeris data and clock error data, as shown in step 42, whereas if it has not, step 40 is repeated. It is then checked whether or not the received navigation signals from the GPS satellites in view of the GPS receiver 20 has been completed, as shown in step 44. If it has, the program goes to a calculating position routine, as shown in step 46, wherein the position calculation of each GPS satellite is initiated based on the received navigation signals of each GPS transmitter 18, whereas if it has not, step 44 is repeated. Accordingly, the present position of each GPS satellite can be calculated based on the received navigation signal.

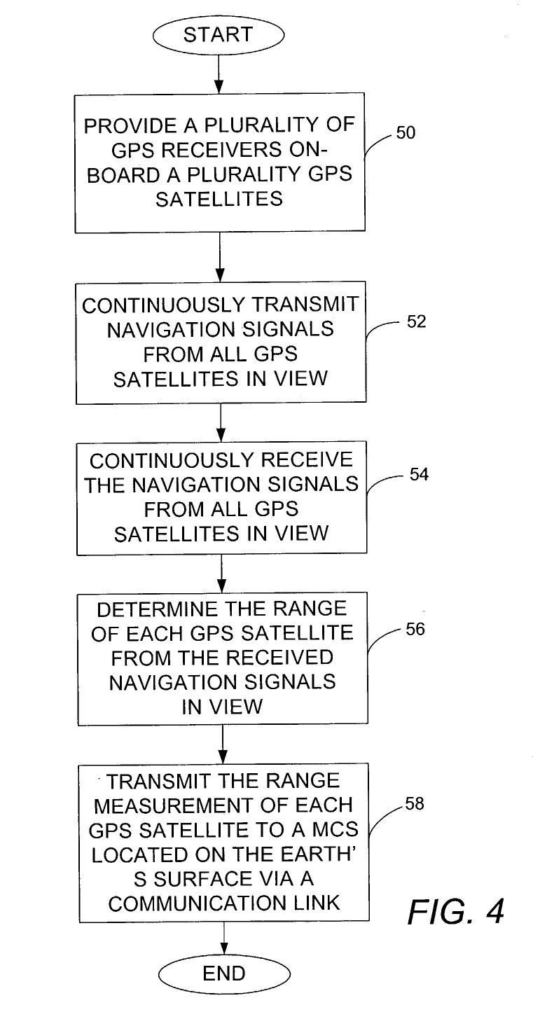

FIG. 4 is a flow chart illustrating exemplary method steps used to practice one embodiment of the present invention. A plurality of GPS receivers are respectively provided on-board the GPS satellites of a GPS constellation, as shown in block 50. Each GPS satellite substantially continuously transmits a navigation signal to the GPS receivers that are in view of the GPS satellite, as shown in block 52. The GPS receivers continuously receive the navigation signals from all GPS satellites in view of the GPS receivers, as shown in block 54. The GPS receivers determine a range to each GPS satellite in view of the GPS receivers from the received navigation signals, as shown in block 56. The range measurement of each GPS satellite is then transmitted via a communication link 32 to a master control station 30 located on the Earth's surface.

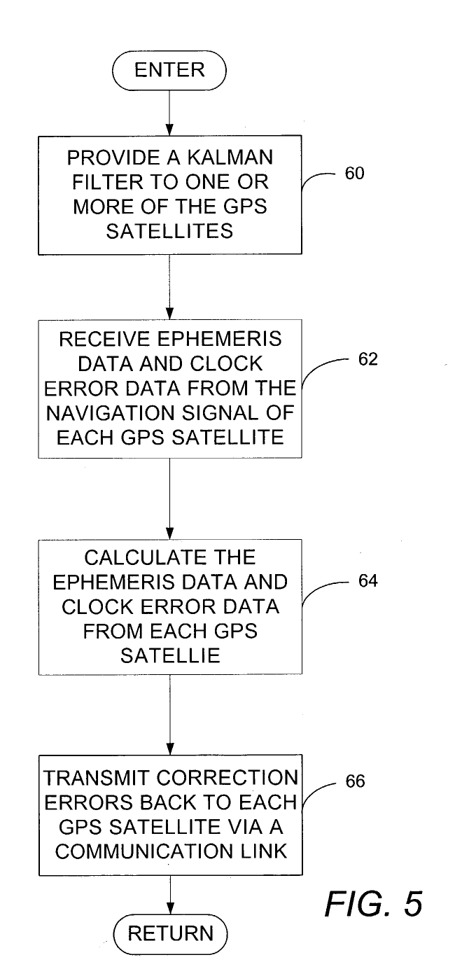

FIG. 5 is a flow chart illustrating exemplary process steps to calculate the ephemeris data and clock error data of a GPS satellite. A Kalman filter is provided on-board one or more of the GPS satellites, as shown in block 60. The Kalman filter receives a navigation signal from each GPS satellite, where the navigation signal includes ephemeris data and clock error data, as shown in block 62. The Kalman filter calculates the ephemeris data and the clock error data, as shown in block 64. The correction errors are then transmitted back to each GPS satellite via a communication link, as shown in block 66.

The method further comprises the step of isolating a faulty satellite navigation signal using five or more satellite navigation signals received by at least one GPS receiver, where the faulty satellite navigation signal can be isolated using algorithms. The fault information is then transmitted back to the affected GPS satellite to form an integrity message that can be added to the navigation signal of the affected satellite.

The on-board GPS receivers will receive the navigation signals transmitted by its host GPS satellite in addition to navigation signals from all the other GPS satellites in view. This signal (from the host satellite) is undesirable and will be much stronger than the desired navigation signals from the other GPS satellites in view. Since the host navigation signal is known precisely, it can be cancelled from the receiver's radio frequency (RF) or from the derived navigation code. This method is common in modem communication systems with demonstrated isolation in excess of 30 db.

This concludes the description of the preferred embodiments of the present invention. In summary, the present invention describes a method and apparatus for continuously monitoring a constellation of 24 Global Positioning System (GPS) satellites in six orbital planes at 55 degrees inclination and 12 sidereal hour periods from space.

The method comprises the steps of providing a plurality of GPS receivers respectively on-board the GPS satellites and substantially continuously receiving at the GPS receivers navigation signals from the GPS satellites in view, and continuously determining a range from the navigation signal of each GPS satellite in view of the GPS receivers.

The apparatus comprises a plurality of GPS receivers respectively installed on-board the GPS satellites for substantially continuously monitoring and receiving navigation signals from other GPS satellites in view of the GPS receivers, and means for determining a range to each GPS satellite in view of the GPS receivers.

### Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing form the spirit and scope of the invention, the invention resides in the claims hereinafter appended.

What is claimed is:

1. An apparatus for continuously monitoring a plurality of Global Positioning System (GPS) satellites in space, comprising:
a plurality of GPS receivers respectively on-board said plurality of GPS satellites for continuously monitoring and receiving navigation signals from said plurality of GPS satellites in view of the plurality of GPS receivers; and
means for determining a range to said each GPS satellite in view of said plurality of GPS receivers.

2. The apparatus of claim 1, wherein said range of said each GPS satellite is transmitted to a master control station via a communication link.

3. The apparatus of claim 1, wherein said navigation signals include ephemeris data and clock error data.

4. The apparatus of claim 3, further comprising at least one Kalman filter on-board at least one of said plurality of GPS satellites for calculating the ephemeris data and the clock error data received from said navigation signals of said each GPS satellite and generating correction error data to transmit back to said each GPS satellite via a communication link.

5. The apparatus of claim 1, wherein said each GPS receiver received its own navigation signal, such that the navigation signal can be cancelled by using the GPS receiver's signal processor.

6. The apparatus of claim 1, wherein five or more satellite navigation signals are simultaneously received by at least one GPS receiver, a faulty satellite navigation signal can be isolated using an algorithm, such that the fault information is transmitted to the affected satellite to form an integrity message that can be added to the navigation signal of the affected satellite.

7. An apparatus for continuously monitoring a constellation of Global Positioning System (GPS) satellites in six orbital planes at 55 degrees inclination and 12 sidereal hour periods from space, the apparatus comprising:
a plurality of GPS receivers respectively mounted on-board said GPS satellites for continuously monitoring and receiving navigation signals from said GPS satellites in view of the GPS receivers;
means for determining a range to said each GPS satellite in view of said plurality of GPS receivers; and
means for calculating ephemeris data and clock error data received from said navigation signals of said each GPS satellite and generating correction error data to transmit back to said each GPS satellite via a communication link.

8. The apparatus of claim 7, wherein said means for calculating the ephemeris data and clock error data includes a Kalman filter.

9. The apparatus of claim 7, wherein said each GPS receiver received its own navigation signal, such that the navigation signal can be cancelled by using the GPS receiver's signal processor.

10. The apparatus of claim 7, wherein five or more satellite navigation signals are simultaneously received by at least one GPS receiver, a faulty satellite navigation signal can be isolated using an algorithm, such that the fault information is transmitted to the affected satellite to form an integrity message that can be added to the navigation signal of the affected satellite.

11. An apparatus for continuously monitoring a constellation of 24 Global Positioning System (GPS) satellites in six orbital planes at 55 degrees inclination and 12 sidereal hour periods from space, the apparatus comprising:
at least 24 GPS receivers respectively installed on-board said 24 GPS satellites for continuously monitoring and receiving navigation signals from said GPS satellites in view of the at least 24 GPS receivers;
means for determining a range to said each GPS satellite in view of said at least 24 GPS receivers; and
at least one Kalman filter installed on-board one of said 24 GPS satellites for calculating ephemeris data and clock error data received from said navigation signals of said each GPS satellite and generating correction error data to transmit back to said each GPS satellite via a communication link.

12. The apparatus of claim 11, wherein said each GPS receiver received its own navigation signal, such that the navigation signal can be cancelled by using the GPS receiver's signal processor.

13. The apparatus of claim 11, wherein five or more satellite navigation signals are simultaneously received by at least one GPS receiver, a faulty satellite navigation signal can be isolated using an algorithm, such that the fault information is transmitted to the affected satellite to form an integrity message that can be added to the navigation signal of the affected satellite.

14. A method of continuously monitoring a plurality of Global Positioning System (GPS) satellites from space, the method comprising the steps of:
respectively providing a plurality GPS receivers on-board said plurality of GPS satellites;
continuously receiving navigation signals from said plurality of GPS satellites in view of said plurality of GPS receivers; and
continuously determining a range from said navigation signals of said each GPS satellite in view of said plurality of GPS receivers.

15. The method of claim 14, further comprising the step of transmitting the range measurement via a communication link to a master control station (MCS) located on the earth's surface.

16. The method of claim 14, wherein said navigation signals include ephemeris data and clock error data.

17. The method of claim 16, further comprising the steps of:
providing at least one Kalman filter on-board one of said plurality of GPS satellites;
receiving the ephemeris data and the clock error data from said navigation signals of said each GPS satellite;
calculating the ephemeris data and the clock error data of said each GPS satellite; and
transmitting correction errors back to said each GPS satellite via a communication link.

18. The method of claim 14, wherein the step of isolating a faulty satellite navigation signal using five or more satellite navigation signals received by at least one GPS receiver, such that the faulty satellite navigation signal can be isolated using an algorithm.

19. The method of claim 18, wherein the step of transmitting the fault information to the affected satellite to form an integrity message that can be added to the navigation signal of the affected satellite.

20. The method of claim 14, wherein said each GPS receiver received its own navigation signal, such that the navigation signal can be cancelled by using the GPS receiver's signal processor.

21. A method of continuously monitoring a constellation of Global Positioning System (GPS) satellites in six orbital planes at 55 degrees inclination and 12 sidereal hour periods from space, the method comprising the steps of:
respectively providing a plurality of GPS receivers on-board said GPS satellites;
continuously monitoring at said plurality of GPS receivers navigation signals from said GPS satellites;
continuously receiving at said plurality of GPS receivers said navigation signals from said each GPS satellite in view; and
continuously determining a range from said navigation signals to said each GPS satellite in view of said plurality of GPS receivers.

22. The method of claim 21, wherein the step of transmitting the range measurement via a communication link to a master control station (MCS) located on the earth's surface.

23. The method of claim 21, wherein said navigation signals include ephemeris data and clock error data of said each GPS satellite.

24. The method of claim 23, further comprising the steps of:
providing at least one Kalman filter on-board one of said GPS satellites;
receiving said navigation signals of said each GPS satellite;
calculating the ephemeris data and the clock error data of said each GPS satellite; and
transmitting correction errors back to said each GPS satellite via a communication link.

25. The method of claim 21, wherein the step of isolating a faulty satellite navigation signal using five or more satellite navigation signals received by at least one GPS receiver, such that the faulty satellite navigation signal can be isolated using an algorithm.

26. The method of claim 21, wherein the step of transmitting the fault information to the affected satellite to form an integrity message that can be added to the navigation signal of the affected satellite.

27. The method of claim 21, wherein said each GPS receiver received its own navigation signal, such that the navigation signal can be cancelled by using the GPS receiver's signal processor.

28. A method of continuously monitoring a constellation of 24 Global Positioning System (GPS) satellites in six orbital planes at 55 degrees inclination and 12 sidereal hour periods from space, the method comprising the steps of:
respectively providing at least 24 GPS receivers on-board said 24 GPS satellites;
continuously monitoring at said at least 24 GPS receivers navigation signals from said GPS satellites in view,
continuously receiving at said at least 24 GPS receivers said navigation signals from said GPS satellites in view,
providing at least one Kalman filter on-board at least one of said GPS satellites, the Kalman filter comprises the steps of:
receiving said navigation signals of said GPS satellites;
calculating the ephemeris data and the clock error data of said each GPS satellite; and
transmitting correction errors back to said each GPS satellite via a communication link.

29. The method of claim 28, wherein the step of isolating a faulty satellite navigation signal using five or more satellite navigation signals received by at least one GPS receiver, such that the faulty satellite navigation signal can be isolated using an algorithm.

30. The method of claim 29, wherein the step of transmitting the fault information to the affected satellite to form an integrity message that can be added to the navigation signal of the affected satellite.

31. The method of claim 28, wherein said each GPS receiver received its own navigation signal, such that the navigation signal can be cancelled by using the GPS receiver's signal processor.
